(19) United States
(12) Patent Application Publication
(10) Pub. No.: US 2006/0161441 A1
(43) Pub. Date: Jul. 20, 2006

(54) Application outsourcing

(76) Inventors: Amir Nathoo, Hampshire (GB); Graham Derek Wallis, Hampshire (GB)

Correspondence Address: IBM CORPORATION;INTELLECTUAL PROPERTY LAW, 11400 BURNET ROAD, AUSTIN, TX, 78758, US

(21) Appl. No.: 10/559,016

(22) PCT Filed: Jun. 23, 2004
(86) PCT No.: PCT/EP04/51203

§ 371 Date: Nov. 29, 2005

(30) Foreign Application Priority Data
Jun. 28, 2003 (GB) 0315187.5

(51) Int. Cl. G06Q 99/00

(52) U.S. Cl. 705/1

(57) ABSTRACT

The invention relates to the coordination of application logic and an associated resource. Application logic is received from an application service provider (ASP) and a request is received from a client requesting a service from the ASP. The application logic from the ASP is matched with the client request. The application logic is used to execute the client request by accessing the resource.

### TECHNICAL FIELD

The present invention relates to the outsourcing of applications to application service providers (ASP).

### BACKGROUND ART

To decrease fixed IT costs, companies (businesses) are increasingly looking to Application Service Providers (ASPs) to supply business applications and services on their behalf (outsourcing). An ASP may develop and tailor applications to meet a customers' (clients' ) needs, or a company may provide the ASP with the applications but leave any maintenance to the ASP.

In either situation, the application and any associated resource(s) (e.g. database; an enterprise server; a legacy application) is hosted on machines outside of the owning company's control. Once the ASP controls a company's critical business resources, that company is heavily reliant upon the ASP and it becomes difficult to change provider without significant costs and risks.

The ASP becomes party to that company's sensitive information/business processes and when the associated resource is a database containing sensitive data (e.g. about their customers, suppliers, partners and business operations), a very real concern for such a company is the protection of that sensitive data.

Currently businesses have two methods to manage and protect their data and other resources:

i) Keep IT systems, data etc. in-house and rely on firewalls and other security technologies applied by their system administrators to protect such resources; or

ii) Outsource systems and rely on the technology and ability of a third party provider (the ASP) to protect/manage the business' resources.

The former has the advantage of keeping (sensitive) resources in-house but means the business loses the advantages of IT outsourcing. The latter means less control over security and reliance on the ASP.

### DISCLOSURE OF INVENTION

Accordingly the invention provides an apparatus for coordinating application logic and an associated resource, the apparatus comprising: means for receiving application logic from an application service provider (ASP); means for receiving a request from a client requesting a service from the ASP; means for matching the application logic from the ASP with the client request; and means for using the application logic to execute the client request by accessing the resource.

According to another aspect, the invention provides an application service provider service, performance of the service comprising the steps of: receiving a request for a service from a client; providing application logic to the apparatus of the preceding paragraph; instructing the client to request a service via the apparatus of the preceding paragraph.

Thus the present invention provides the ability to outsource the provision of application logic to Application Service Providers, whilst permitting a company to retain control over the resource(s) with which such application logic interacts.

Such an apparatus could be used to separate banking application logic from customers' sensitive bank details. By way of another example, the apparatus could be one part of an electronic payment system. (U.S. Pat. No. 6,029,150 is another example of an electronic payment system however this system does not match application logic (received from an ASP) with a client request and execute the application logic (by accessing a resource) in order to fulfill the client's request.)

The request may include data inserted by the client—in which case this data is preferably used in executing the request.

Preferably the result of the request is returned to the client in a format specified by the application logic.

Preferably the result is returned with a correlator identifier (id). Thus if a second request is received from the client including the same correlator id, this can be used to correlate the second request with a previous request. Thus the correlator id feature can be used to group a number of requests into a single unit of work.

The application logic, in accordance with a preferred embodiment, comprises at least one web page. An appropriate web page can be selected to return to the client based on the result of executing application logic.

In one embodiment the resource is a database and the returned web page includes data extracted from the database.

In another embodiment the resource is accessed via intermediate logic—for example an application server.

According to another aspect, the invention provides an apparatus according to claim 8.

According to another aspect, the invention provides a system according to claim 9.

According to another aspect, the invention provides a client comprising: means for requesting a service from an application service provider (ASP); means for receiving details of how to enable performance of the service, the details comprising an identifier and an address to forward the identifier to; means for forwarding the identifier to the address in order that the identifier can be matched with associated application logic from the ASP, the application logic for performing the client request using a resource, the client further comprising means for receiving the result of the request back from the address.

Preferably the means for forwarding the identifier comprises means for also forwarding data (e.g. provided by the client) to the address. This data can then be used in processing the request.

Preferably, the client also comprises means for receiving a correlator id back from the address; and means for using the correlator id to associate later requests sent to the same address.

According to another aspect, the invention provides a method for coordinating application logic and an associated resource, the apparatus comprising: receiving application logic from an application service provider (ASP); receiving a request from a client requesting a service from the ASP; matching the application logic from the ASP with the client request; and using the application logic to execute the client request by accessing the resource.

According to another aspect, the invention provides a method according to claim 20.

According to another aspect, the invention provides a method comprising: requesting a service from an application service provider (ASP); receiving details of how to enable performance of the service, the details comprising an identifier and an address to forward the identifier to; forwarding the identifier to the address in order that the identifier can be matched with associated application logic from the ASP, the application logic for performing the client request using a resource, the method further comprising receiving the result of the request back from the address.

Preferably data is also forwarded to the address. A correlator id may be received back from the address and used to associate later requests sent to the same address.

According to another aspect, the invention provides a resource management service for coordinating application logic and an associated resource, performance of the service comprising the method steps of: receiving application logic from an application service provider (ASP); receiving a request from a client requesting a service from the ASP; matching the application logic from the ASP with the client request; and using the application logic to execute the client request by accessing the resource.

It will be appreciated that the present invention/parts thereof may be implemented in computer software.

### BRIEF DESCRIPTION OF THE DRAWINGS

Embodiments of the present invention will now be described, by way of example only, and with reference to the following drawings:

FIG. 1a is a component diagram of a preferred embodiment of the present invention;

FIG. 1b illustrates the processing of the present invention in accordance with the preferred embodiment;

FIG. 2 shows a direct electronic payment system implemented in accordance with an embodiment of the present invention; and

FIG. 3 is a component diagram of an embodiment of the present invention.

### MODE FOR THE INVENTION

The present invention is applicable to the separation of sensitive resource(s) (e.g. data) from outsourced application logic; the separation of outsourced application logic from in-house resource(s) such as application(s); and is also applicable for use with multiple ASPs and multiple resources.

The present invention will be described in terms of a web environment, it should however be appreciated that the invention is not intended to be limited to such. For example, it would be possible to construct a system using different components—e.g. in place of the web server and/or web browser there would be other components using custom formats and protocols to enable the various components of the system to interoperate.

In accordance with one embodiment, the invention provides a method for separating e-business applications from their data stores. In this way, applications can be outsourced to application service providers (ASPs) without exposing any sensitive data required for the operation of such applications. One example of where this might be particularly useful is in online banking. Customer bank records can be retained in-house, whilst the banking application necessary to provide customers with access to their accounts can be outsourced.

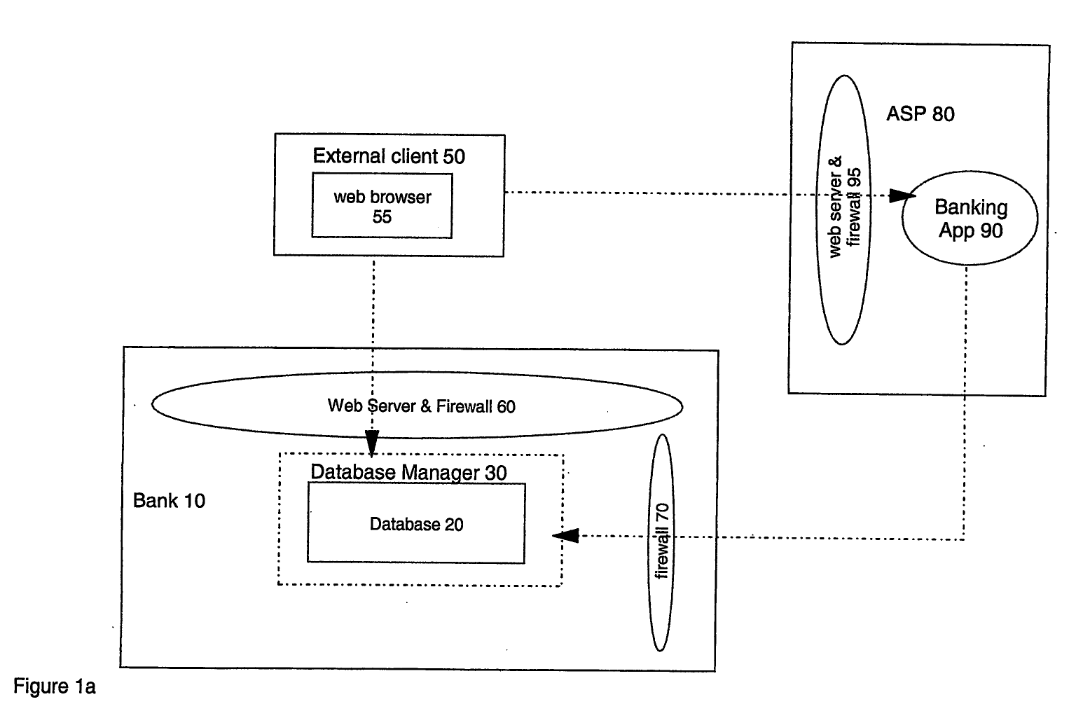

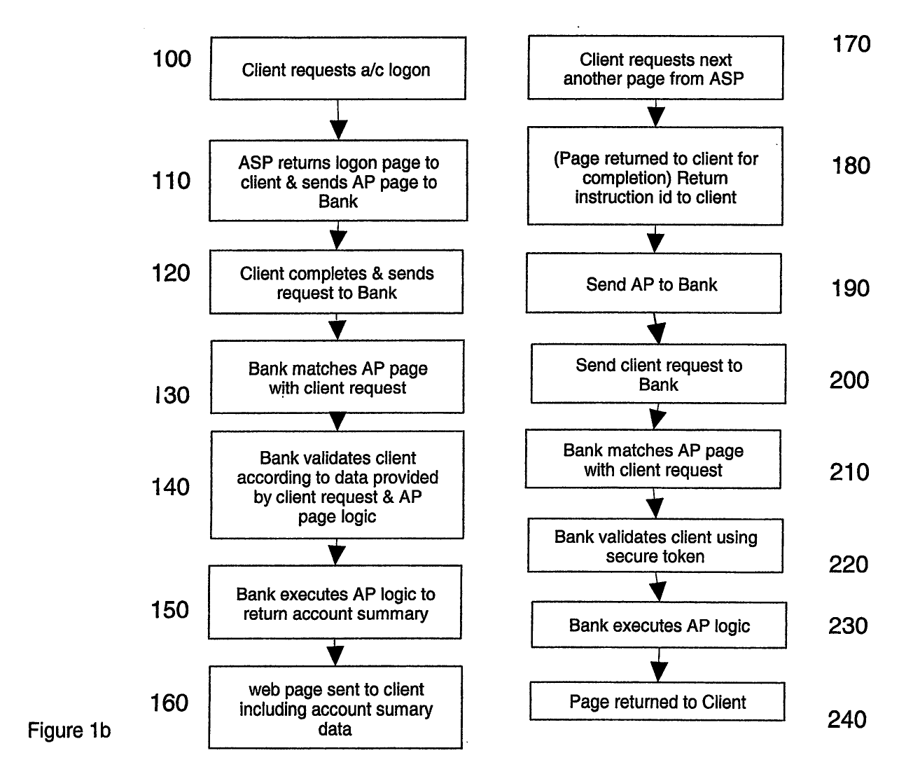

FIG. 1a is a component diagram of a preferred embodiment of the present invention. A company, such as a bank 10, retains sensitive data about its customers (clients) in database 20. Database 20 is accessed by external clients 50 (one shown) through web server and firewall 60, via a custom-built database manager 30.

The company outsources its applications (one example shown—a banking application 90) to an ASP 80 which is accessible by external clients 50 through web server and firewall 95. The ASP can access the database manager 30 (and consequently the database 20) through firewall 70, however no sensitive data is returned from the database to the ASP. In this way the ASP is completely unaware as to the contents of database and thus security is less likely to be compromised.

FIG. 1b illustrates the processing of a preferred embodiment of the present invention when used for online banking. It should be read in conjunction with FIG. 1a.

A client 50 enters the URL of the ASP into web browser 55 in order to access the banking application 90 through the web server and firewall 95. The client requests an account (a/c) logon (step 100). The ASP returns the logon page to the client for completion and at the same time, the ASP sends an application page (described in detail later) (AP) to database manager 30 (step 110). Note, the database manager may confirm receipt of the AP to the ASP.

The AP includes a unique instruction id which is allocated to it by the ASP. The same instruction id is also provided as part of the logon page returned to the client. The client completes the logon information and a client request is constructed and transmitted to the bank (step 120). The client request preferably includes:

(i) the instruction id extracted from the logon page;

(ii) a filter code comprising the client completed logon details; and

(iii) a client return address (where needed by the protocol being used).

Since the initial logon page sent to the client preferably includes the address of the bank, this information can be used to transmit the client request to the bank, where it is forwarded onto the database manager 30.

The database manager 30 upon receipt of the client request is able to match it (using the instruction id field) with the corresponding AP (step 130). Note, the AP may include a timeout value. If the AP has not been matched with a client request within the time period specified by the timeout value, then the AP preferably expires. The database manager/AP is preferably programmed with instructions on what to do after an AP expires. For example, to ignore client request/return “Page Expired” message to the client/return the previous page such that the client can restart the transaction again etc.

Assuming that the AP can be matched with a client request, the database manager executes logic contained within the AP using the data contained within the client request's filter code. The AP contains HTML pages which can be selected as appropriate and completed using data from database 20. Note, application logic (including HTML pages) is preferably provided by the ASP.

In this example, the AP contains logic for using client logon data to validate the client against database 20 (step 140). Such logic is likely to be of the form:

if client logon

validate client against database using filter code data
If client invalid
select HTML page with message requesting that the client try again
//client is not

valid

send selected HTML page to client (using client address
extracted from client request where necessary)
Else // client is valid
generate secure token identifying particular client
execute additional logic to mimic new client request for
account summary
End

End

//having logged the client on, the client is to be provided with a
//summary of their

account status

// the mimicking client request should include the same instruction
// id as the

initial request and thus can be matched with the initial // AP in order
for account
summary logic to be executed - see below. // (Note a flag can be used
to indicate
whether the AP is being used // to logon or to provide account summary
details.)

// the mimicking client request should include the secure token
// generated by the logon process
// the mimicking client request should also include the client reply
// address extracted from the initial client request (if appropriate)
If account summary being requested
validate secure token
if not valid
select HTML page with message requesting that the
client logon again //client is not valid
extract client return address from client request (if
appropriate) and send
selected HTML page to client
Else // secure token valid
query database for account summary data
select appropriately formatted HTML page and insert account
summary data
extract reply destination from client request (if appropriate)
and return selected HTML page to client
// returned HTML page should include secure token for future // use
by the client.
End

End

Using this AP logic, a client's logon details may be validated against database 20; account summary logic may be executed (step 150); and a web page returned to the client including account summary details (step 160).

The account summary details page returned to the client preferably includes a menu pertaining to additional requests which the client may make to the ASP. Assuming the client selects one of these (step 170), the ASP will either return a page (including a new instruction id) to the client for completion or will simply return the new instruction id (if there is no data for the client to complete)—step 180. A page might be returned to the client for completion if the client wishes to update some data—e.g. their address.

At the same time an AP (including the new instruction id and appropriate logic) is sent to the bank (step 190).

Meantime, client 50 constructs a client request including:

i) a filter code including completed data (if appropriate);

ii) the client's return address (if appropriate);

iii) the secure token it received as part of the logon process; and

iv) the new instruction id.

This is transmitted to the bank (step 200).

At step 210 the bank matches the client request with the newly received AP (via the new instruction id contained within both). This AP contains logic of the form:

validate secure token
if not valid
select HTML page with message requesting that the
customer logon again //customer is not valid
extract client return address (if appropriate) from client request
and send page to

client

Else // secure token valid
query/update database as appropriate
if database being queried
select appropriately formatted HTML page and insert
extracted data
extract reply destination from client request (if appropriate) and
return page to client
// return page should include secure token.
Else //database being updated
selected appropriate HTML page (from AP) for informing the client
that their

update has been actioned

extract reply destination from client request (if
appropriate) and return page to client
// return page should include secure token.
End
End

In this way, the bank is able to validate the client using the secure token (step 220), execute logic contained within the AP (step 230); and return the appropriate HTML page to the client (step 240).

It will thus be appreciated that database manager 30 preferably includes a list of commands which may be executed against the database and which it knows how to execute in order to extract the appropriate data/modify the data appropriately.

Preferably no sensitive data is ever received by the application service provider. Database manager 30 employs normal security measures to authenticate the identity of the client and the ASP and to ensure privacy of sensitive data.”

The database manager preferably refuses to send sensitive data (e.g. an account balance) to a different address than that of the requesting client.

The database interface may also provide some degree of audit facility. For example the interface may keep track of the number of requests which matched APs; the number of rejected requests; the number of timeouts etc. Since such auditing is done in-house (as opposed to being done by the ASP), the accuracy of such data can be guaranteed.

Whilst the invention is particularly applicable to the separation of outsourced application logic from associated sensitive data, it is by no means limited to such.

By way of another example, different ASPs could be used to separately outsource different (cooperating) parts of a larger application. According to one such embodiment, a direct electronic payment system is disclosed. When making purchases over the web or through other electronic media, this system permits that a customer's sensitive personal and bank details are only ever sent to their bank. The supplier of whatever they were ordering is only informed that the transaction had been requested and when it had taken place.

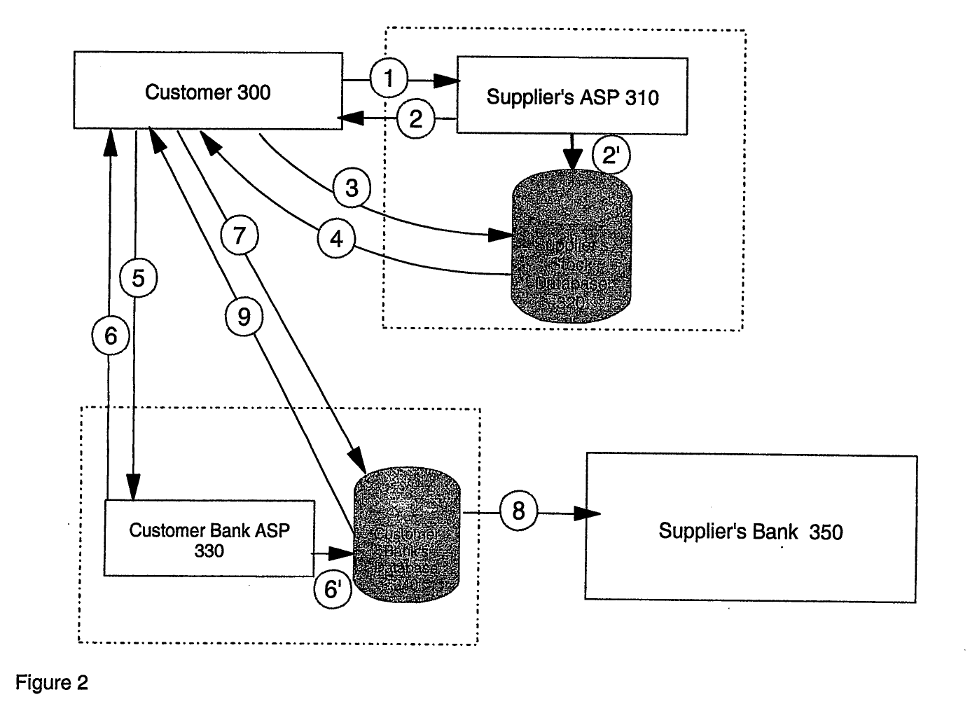

FIG. 2 illustrates the components and processing involved in such a system in accordance with one embodiment of the present invention. Note, in this embodiment there are two ASPs—one for the supplier and one for the customer's bank. In this way the customers' bank details are kept separate from the entity hosting the customer banking application and similarly the supplier's stock details are kept separate from the entity hosting the supplier application (e.g. website).

From the figure it can be seen that the flow of information between components is shown via numbered arrows. The following explains what each numbered arrow means:

1 A customer (client) 300 browses a supplier's website (which is hosted and managed by the supplier's ASP 310) and issues a purchase request for a particular stock item.

2 The supplier's ASP 310 sends a request for the customer which includes an instruction id and a template for the customer to complete. The template preferably includes space for the customer to complete the part number of the item that they wish to purchase.

2′ At the same time, the supplier's ASP 310 sends an AP to the stock database. The AP includes the same instruction id as that allocated to the client request at step 2.

3 The customer completes the template sent as part of the request at step 2 and sends the completed client request to the supplier's stock database 320. The supplier's stock database manager (not shown) matches the client request and the AP (sent at step 2′) and this causes (due to logic contained within the AP) an HTML page to be sent to the customer at step 4.

4 The HTML page is sent to the customer 300 and contains the price of stock item and also details regarding the suppliers bank (e.g. bank name and suppliers name).

5 The customer informs the Customer Bank ASP 330 that a purchase is being initiated.

6 The Customer Bank ASP 330 generates a client request for the customer. Such a request includes an instruction id, space for the customer to fill in the price and also the supplier's bank details (the latter two being obtained from the AP sent by the supplier's stock database at step 4).

6′ At the same time, the Customer Bank ASP 330 generates an AP to send to the Customer Bank's Database 340. This AP includes the same instruction id as that provided by the client request of step 6.

7 The customer sends the client request received at step 6, duly completed, to the Customer Bank's Database 340. The client request will also include customer bank logon information in order that the customer can be authenticated as a true customer. The Customer Bank's Database manager (not shown) can then match the AP of step 6′ with the client request of step 6.

8 Assuming that the AP and client request can be matched, the AP includes logic which enables the Customer Bank's database manager to first validate the customer and then to interact with the supplier's bank in order that the customer's bank account can be debited and the supplier's bank account can be credited. Note, the Supplier's Bank 350 is not necessarily using the separated application logic/data methodology of an embodiment of the present invention. Thus the customer bank's database manager and the supplier's bank may interact in accordance with standard payment clearing methods.

The logic provided within the AP of step 6′ also enables the Customer Bank's Database manager to provide confirmation that the transaction has taken place to the Customer 300 once the Customer Bank's Database manager receives confirmation of this (not shown) from the supplier's bank 350 in the form of an HTML page.

On receipt of confirmation, the customer issues a shipping request (including their address) via the supplier's website and in the same manner as the previously described transactions. The supplier, having confirmed with their own bank that the payment has been made, can confirm the shipment and the order is complete.

Note, the Supplier's ASP 310 and the Customer Bank ASP should preferably being using a standard format of client request.

Note, the Customer Bank ASP is a separate entity from the Customer Bank's Database and the same is true of the Supplier's ASP and supplier's stock database. Each entity is under the control of somebody different. It will be appreciated that both databases make use of a database manager (not shown) in a similar way to that described with reference to FIGS. 1a and 1b.

Preferably, where multiple client requests each form a part of one operation, each client request contains a correlator that can be used to relate it to the larger operation. Similarly, responses related to the operation should preferably convey the same correlator. The correlator can be considered as part of the “payload” of the requests and responses of which the application is comprised.

It will be appreciated that, with a typical payment system a customer would provide a supplier with their bank details/credit card details in order for the supplier to action a payment. In doing this, the customer trusts that the supplier will not misuse their sensitive data. If the supplier has outsourced their purchasing application, then previously the customer would have had to trust the supplier's ASP and this in itself might not be desirable. By using the present invention, a customer's sensitive data is preferably only ever transmitted between the customer and the bank.

Whilst the invention has mainly been described in terms of separation of application logic from sensitive data, the invention is not limited to such. A system may, in accordance with an embodiment of the invention, coordinate interaction between a client and any resource that the client might want to access. Whilst that resource may be a database, it could just as easily be an enterprise server or non-outsourced applications/application parts.

Thus the invention preferably allows a company to keep some of its resources in-house (where it has all the expertise to manage those resources), whilst outsourcing other resources.

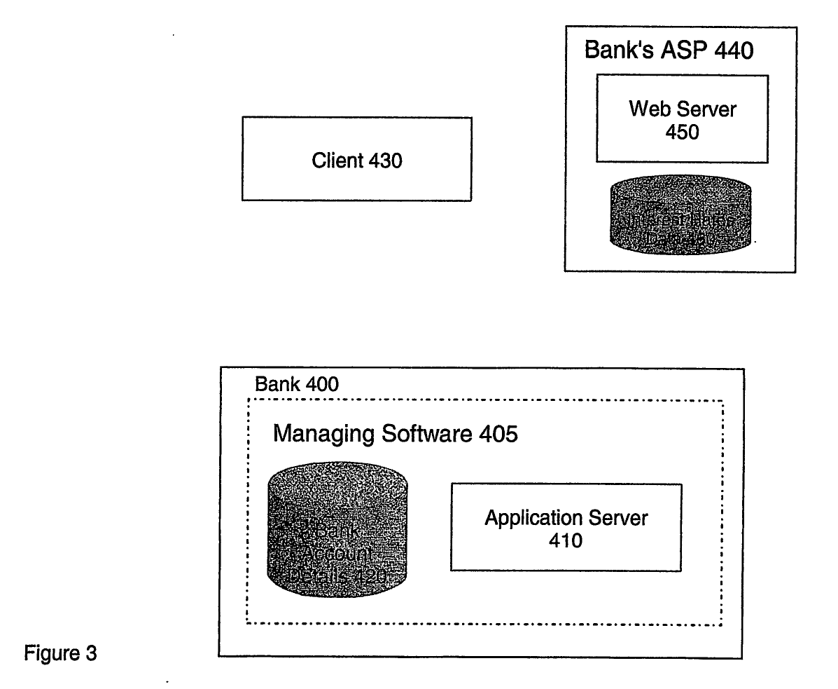

FIG. 3 provides an example in which a bank provides a service to its customers by responding to requests for account details; interest rates; mortgage information etc. The bank chooses to outsource part of this service to an ASP 440. Through a web server 450, a customer 430 is able to make requests for information. The bank's ASP 440 has direct access to certain non-sensitive information such as current interest rates (using database 460). The bank 400 has however chosen to retain part of its service in house. An application server 410 is controlled by the bank and used to action requests for sensitive information such as a customer's bank details. Such sensitive information is held in database 420 which is again retained under the control of the bank itself and not the Bank's ASP. Both the database 420 and the application server 410 are accessible via managing software 405.

Such a system works in much the same way as the banking system described with reference to FIGS. 1a and 1b. The main difference in this case is that there is an application server sitting between the bank's ASP and the bank's database 420. The managing software 405 simply translates the application logic which it receives from the bank's ASP 440 into a format which the bank's application server 420 is able to understand. The application server can use such requests to query database 420.

Note, the bank may choose to use the application server since this may have been specially tailored to the bank's needs. There is little point in having an ASP develop something new, when the application server is already available for use. Further the bank may choose to retain the application server in-house due to specialist skills which it may require.

Note, whilst the invention has been described in terms of customers external to a company that has outsourced the provision of their application, the invention is by no means limited to such. Internal users of the outsourced application may also use this invention in a similar manner to access the required resources.

1. A resource manager apparatus for coordinating application logic hosted by an Application Service Provider (ASP) with a resource managed by a resource manager separate from the ASP, the apparatus comprising:
means for receiving application logic and an associated instruction id from the ASP, both the application logic and the id being sent to the resource manager as a result of a request for a service received at the ASP from a client;
means for receiving a request from the client including the instruction id, the instruction id having been generated by the ASP and having been returned to the client for forwarding to the resource manager;
means for matching the instruction id received from the ASP with the instruction id received from the client in order to identify the associated application logic;
means for using the identified application logic to execute the client request by accessing and using the resource in conjunction with the application logic; and
means for providing the result of the client request to the client, wherein the application logic is received via a communications channel between the ASP and the resource manager and the result is provided to the client via a separate communications channel between the resource manager and the client.

2. The apparatus of claim 1, wherein the request includes data inserted by the client, the apparatus comprising: means for using the data in executing the request.

3. The apparatus of claim 1, comprising: means for returning the result of said request, in a format specified by the application logic, to the client.

4. The apparatus of claim 3, wherein the means for returning further provides a correlator identifier and the apparatus further comprises:
means for receiving a second request from the client including the correlator identifier; and
means for correlating the second request with a previous request.

5. The apparatus of claim 3, wherein the application logic comprises at least one web page, the apparatus comprising: means for selecting an appropriate web page from the application logic to return to the client based on the result of executing application logic.

6. The apparatus of claim 5, wherein the resource is a database and the returned web page includes data extracted from the database.

7. The apparatus of claim 1, wherein the resource is accessed via intermediate logic.

8. The apparatus of claim 1, further comprising an apparatus for use by an application service provider, comprising:
means for receiving a request for a service from a client;
means for providing application logic and an associated instruction id to the resource manager;
means for also providing the instruction id to the client for forwarding to the resource manager apparatus to initiate the service.

9. The apparatus of claim 1, wherein the application service provider comprises:
means for receiving the request for a service from a client;
means for providing the application logic and the associated instruction id to the resource manager; and
means for providing the instruction id to the client for forwarding to the resource manager to initiate the service.

10. A client comprising:
means for requesting a service from an application service provider (ASP);
means, responsive to the request, for receiving details of how to enable performance of the service from the ASP, the details comprising an identifier for forwarding to a resource manager managing a resource, the resource needed in order to perform the requested service, wherein the identifier is also sent along with associated application logic from the ASP to the resource manager as a result of the client's request to the ASP; and
means for forwarding the identifier from the client to the resource manager in order that the identifier can be matched with the associated application logic received from the ASP by the resource manager using the identifier received from the ASP, the client further comprising: means for receiving the result of the request back from the resource manager, the result having been achieved at the resource manager by the resource manager accessing and using the resource in conjunction with the application logic to execute the client request, wherein the client request is sent via a communications channel between the client and the ASP and the identifier and results are sent via a separate communications channel between the client and the resource manager.

11. The client of claim 10, wherein the details include an address to forward the identifier to, the client further comprising: means for also forwarding data to the address.

12. The client of claim 10, wherein the details include an address to forward the identifier to the client further comprising: means for receiving a correlator id back from the address; and means for using the correlator id to associate later requests sent to the same address.

13. A resource manager method for coordinating application logic hosted by an Application Service Provider (ASP) with a resource managed by a resource manager separate from the ASP, the method comprising:
receiving application logic and an associated instruction id from the ASP, both the application logic and the id being sent to the resource manager as a result of a request for a service received at the ASP from a client;
receiving a request from the client including the instruction id, the instruction id having been generated by the ASP and having been returned to the client for forwarding to the resource manager;
matching the instruction id received from the ASP with the instruction id received from the client in order to identify the associated application logic;
using the identified application logic to execute the client request by accessing and using the resource in conjunction with the application logic; and
providing the result of the client request to the client, wherein the application logic is received via a communications channel between the ASP and the resource manager and the result is provided to the client via a separate communications channel between the resource manager and the client.

14. The method of claim 13, wherein the application service provider performs the steps comprising:
receiving the request for a service from a client;
providing the application logic and an associated instruction id; and
providing the instruction id to the client for forwarding to the resource manager method to initiate the service.

15. A computer program comprising program code means adapted to perform a method of coordinating application logic hosted by an Application Service Provider (ASP) with a resource managed by a resource manager separate from the ASP, when said program is run on a computer said computer program code means comprising:
computer program code means for receiving a request from the client including the instruction id, the instruction id having been generated by the ASP and having been returned to the client for forwarding to the resource manager:
computer program code means for matching the instruction id received from the ASP with the instruction id received from the client in order to identify the associated application logic:
computer program code means for using the identified application logic to execute the client request by accessing and using the resource in conjunction with the application logic: and
computer program code means for providing the result of the client request to the client, wherein the application logic is received via a communications channel between the ASP and the resource manager and the result is provided to the client via a separate communications channel between the resource manager and the client.

16. The computer program of claim 15, wherein the ASP comprises:
computer program code means for receiving the request for a service from a client;
computer program code means for providing the application logic and an associated instruction id; and
computer program code means for providing the instruction id to the client for forwarding to the resource manager method to initiate the service.

17. A client method comprising:
requesting a service from an application service provider (ASP);
responsive to the request, receiving details of how to enable performance of the service from the ASP, the details comprising an identifier for forwarding to a resource manager managing a resource, the resource needed in order to perform the requested service, wherein the identifier is also sent along with associated application logic from the ASP to the resource manager as a result of the client's request to the ASP;
forwarding the identifier from the client to the resource manager in order that the identifier can be matched with the associated application logic received from the ASP by the resource manager using the identifier received from the ASP, the client method further comprising: receiving the result of the request back from the resource manager, the result having been achieved at the resource manager by the resource manager accessing and using the resource in conjunction with the application logic to execute the client request, wherein the client request is sent via a communications channel between the client and the ASP and the identifier and result are sent via a separate communications channel between the client and the resource manager.

18. The method of claim 17, wherein the details include an address to forward the identifier to, the client method further comprises: also forwarding data to the address.

19. The method of claim 17, wherein the details include an address to forward the identifier to, the client method further comprises: receiving a correlator id back from the address; and means for using the correlator id to associate later requests sent to the same address.

20. The computer program of claim 15, said computer program code means further comprising:
computer program code means for a client requesting a service from an application service provider (ASP);
computer program code means responsive to the request, receiving details of how to enable performance of the service from the ASP, the details comprising an identifier for forwarding to a resource manager managing a resource, the resource needed in order to perform the requested service, wherein the identifier is also sent along with associated application logic from the ASP to the resource manager as a result of the client's request to the ASP:
computer program code means for forwarding the identifier from the client to the resource manager in order that the identifier can be matched with the associated application logic received from the ASP by the resource manager using the identifier received from the ASP, the computer program code means further comprising: computer program code means for receiving the result of the request back from the resource manager, the result having been achieved at the resource manager by the resource manager accessing and using the resource in conjunction with the application logic to execute the client request, wherein the client request is sent via a communications channel between the client and the ASP and the identifier and result are sent via a separate communications channel between the client and the resource manager.

21. (canceled)
